(19) United States
(12) Patent Application Publication
(10) Pub. No.: US 2024/0086923 A1
(43) Pub. Date: Mar. 14, 2024

(54) ENTITY PROFILE FOR ACCESS CONTROL

(71) Applicant: EQUIFAX INC., Atlanta, GA (US)

(72) Inventors: Priya SARATHY, Atlanta, GA (US); Sukesh KUMAR, Alpharetta, GA (US); Lalit KATARIA, Alpharetta, GA (US); Duncan FREEMAN, Alpharetta, GA (US); Sri Ram TIRUNELLAYI, Alpharetta, GA (US)

(21) Appl. No.: 17/930,970

(22) Filed: Sep. 9, 2022

(51) Int. Cl. G06Q 20/40

(52) U.S. Cl. CPC G06Q 20/4016; G06Q 20/4015

(57) ABSTRACT

A system can efficiently control access to an interactive computing environment using an entity profile. The system can receive entity data relating to a target entity. The entity data can include real-time data and external data. The system can extract features from the entity data. The system can generate signals based on the features. Each signal can include a subset of the features, and each signal can correspond to an amount of risk associated with the target entity. The system can generate, based on the signals, an entity profile. The system can provide a responsive message based on the entity profile that can be used to control access to an interactive computing environment.

### TECHNICAL FIELD

The present disclosure relates generally to risk assessment and access control. More specifically, but not by way of limitation, this disclosure relates to controlling access to an interactive computing environment using an entity profile.

### BACKGROUND

Various interactions are performed frequently through an interactive computing environment such as a website, a user interface, etc. Controlling access to the interactive computing environment is important to the security and performance of the system. Access to the environment can be controlled through conventional means such as a username/password combination, multi-factor authentication, and the like. But the conventional means may not consider other factors about an entity that may affect a risk associated with granting the entity access to the interactive computing environment.

### SUMMARY

Various aspects of the present disclosure provide systems and methods for controlling access of a computing device to an interactive computing environment using an entity profile. The system can include a processor and a non-transitory computer-readable medium that includes instructions are executable by the processor to cause the processor to perform various operations. The system can receive entity data relating to a target entity. The entity data can include real-time data and external data. The system can extract features from the entity data. The system can generate signals based on the features. Each signal can include a subset of the features, and each signal can correspond to an amount of risk associated with the target entity. The system can generate an entity profile based on the signals. The system can provide a responsive message based on the entity profile that can be used to control access to an interactive computing environment.

In other aspects, a method can efficiently control access to an interactive computing environment using an entity profile. Entity data relating to a target entity can be received. The entity data can include real-time data and external data. Features can be extracted from the entity data. Signals based on the plurality of features can be generated. Each signal can include a subset of the features, and each signal can correspond to an amount of risk associated with the target entity. An entity profile can be generated based on the signals. A responsive message can be provided based on the entity profile to control access to an interactive computing environment.

In other aspects, a non-transitory computer-readable medium can include instructions that are executable by a processing device for causing the processing device to perform various operations. The operations can include receiving entity data relating to a target entity. The entity data can include real-time data and external data. The operations can include extracting features from the entity data. The operations can include generating signals based on the features. Each signal can include a subset of the features, and each signal can correspond to an amount of risk associated with the target entity. The operations can include generating, based on the signals, an entity profile. The operations can include providing a responsive message based on the entity profile that can be used to control access to an interactive computing environment.

This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

The foregoing, together with other features and examples, will become more apparent upon referring to the following specification, claims, and accompanying drawings.

### BRIEF DESCRIPTION OF DRAWINGS

FIG. 1 is a block diagram depicting an example of a computing environment in which access to an interactive computing environment can be controlled using an entity profile according to certain aspects of the present disclosure.

FIG. 2 is a flow chart depicting an example of a process for generating an entity profile according to certain aspects of the present disclosure.

FIG. 3 is a flow chart depicting an example of a process for controlling access to a computing environment using an entity profile according to certain aspects of the present disclosure.

FIG. 4 is a schematic depicting an example of an architecture of an entity profile model for generating an entity profile according to certain aspects of the present disclosure.

FIG. 5 is a diagram depicting a visualization of an entity profile according to certain aspects of the present disclosure.

FIG. 6 is a block diagram depicting an example of a computing system suitable for implementing aspects of the techniques and technologies presented herein.

### DETAILED DESCRIPTION

Controlling access to an interactive computing environment properly can improve the security of the interactive computing environment. For example, requiring a username/password combination, multi-factor authentication, biometric authentication, and the like can provide security for sensitive accounts or data included in the interactive computing environment. But these techniques may not involve or otherwise consider whether the entity attempting to access the interactive computing environment is associated with increased security or malicious action risk.

Certain aspects described herein for controlling access to the interactive computing environment using an entity profile can address one or more issues identified above. For example, the entity profile can include or can be used to determine one or more different scores for use in determining whether to grant access to the interactive computing environment to a target entity associated with the entity profile. The target entity can include a user (e.g., an individual) or other suitable type of entity. The entity profile can include the one or more different scores and can be determined based on various data. For example, the entity profile can be determined based on entity data that includes one or more of (i) real-time data, which is streamed from external data sources, about the target entity, (ii) real-time data, which is produced from internal data sources, about the target entity, and (iii) historical interaction data about the target entity. The entity profile can include a continuously updated profile that indicates risk associated with the target entity accessing the interactive computing environment or accessing other suitable services.

In some examples, the entity profile can include a set of scores associated with the target entity. The set of scores can include (i) one or more scores indicating a likelihood that the target entity is involved, or may subsequently be involved, with fraud, (ii) one or more scores indicating a likelihood that the target entity may follow through on debts, and (iii) any other suitable scores that can be used to determine whether to grant access to the interactive computing environment to the target entity. In some examples, the set of scores can include a credit score, a fraud score, and the like.

The interactive computing environment can be provided by a client computing system. For example, the client computing system can be an entity that may provide software as a service, infrastructure as a service, and other suitable services accessible by a user computing system that can be used by the target entity. In some examples, the interactive computing environment can include a user interface. The target entity can use the user computing system to request access to a particular user interface that can be used to request services or other suitable computing resources from the client computing system. For example, the target entity can request a financial loan, cloud computing storage resources, or any other suitable services or computing resources from the client computing system via the interactive computing environment. In other examples, the interactive computing environment can include one or more websites or sub-pages thereof. For example, the interactive computing environment can include a secure website provided by the client computing system. The secure website can include cloud computing storage or other resources, and the client computing system can control access of the target entity to the secure website via the entity profile and, optionally, other suitable security techniques such as multi-factor authentication, username/password combinations, etc.

In some examples, the entity profile can be used for other suitable purposes in addition to controlling access to the interactive computing environment. For example, the entity profile can be used to verify an identity of the target entity, to determine whether to provide real-world goods and/or services, and the like. The entity profile can include one or more scores that can be used to determine, for example with respect to an online or real-world interaction, a likelihood that the target entity has provided a genuine identity. In another example, a client, such as a provider of restricted or regulated goods or services, can use the entity profile to determine whether to provide the restricted or regulated goods or services to the target entity. In some examples, the entity profile can be used for digital enablement of an interaction with respect to the target entity by identifying the target entity in multiple dimensions.

Certain aspects described herein, which can include determining the entity profile and controlling access to the interactive computing environment based on the entity profile, can improve the technical field of access control for a computing environment. For instance, by using the entity profile, a risk assessment computing system may provide legitimate access to the interactive computing environment using fewer computing resources compared to other risk assessment systems. For example, the entity profile can be determined using a subset of data received about the target entity. In one such example, the risk assessment computing system that generates the entity profile can tag (e.g., label) data points of the data received with respect to the target entity. The tags can include determining whether the data points of the data are each passive, active, or neither. Passive data may not correspond or contribute to one or more of the scores that may be included in, or may be determined using, the entity profile, while active data may correspond or contribute to one or more of the scores that may be included in, or may be determined using, the entity profile. The risk assessment computing system can archive or delete the passive data, thereby using fewer computing resources (e.g., processing power, computer memory, etc.) to generate the entity profile to control access to the interactive computing environment. Accordingly, the risk assessment computing system improves the access control for computing environment by reducing memory usage, processing time, network bandwidth consumption, response time, and the like with respect to controlling access to the interactive computing environment.

These illustrative examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative examples but, like the illustrative examples, should not be used to limit the present disclosure.

### Operating Environment Example for Controlling Access to a Computing Environment

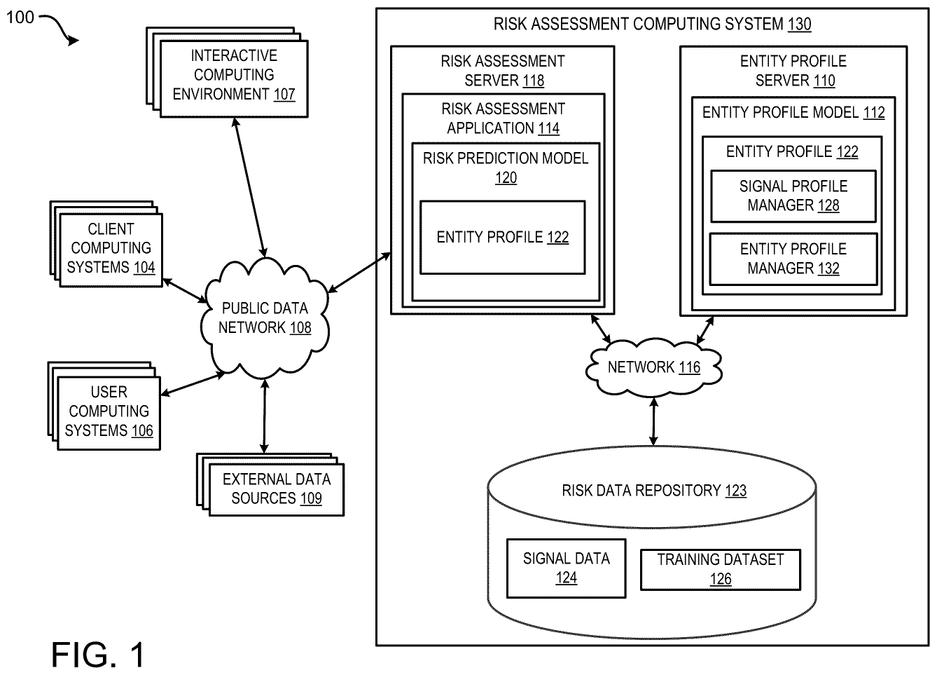

Referring now to the drawings, FIG. 1 is a block diagram depicting an example of a computing environment 100 in which access to an interactive computing environment 107 can be controlled using an entity profile 122 according to certain aspects of the present disclosure. FIG. 1 depicts examples of hardware components of a risk assessment computing system 130, according to some aspects. The risk assessment computing system 130 can be a specialized computing system that may be used for processing large amounts of data (e.g., for controlling access to the interactive computing environment 107, etc.) using a large number of computer processing cycles. The risk assessment computing system 130 can include a risk assessment server 118 for validating risk assessment data from various sources. In some examples, the risk assessment computing system 130 can include other suitable components, servers, subsystems, etc.

The risk assessment server 118 can include one or more processing devices that can execute program code, such as an entity profile model 112, a risk assessment application 114, and the like. The program code can be stored on a non-transitory computer-readable medium or other suitable medium. The entity profile model 112 can execute one or more processes to generate the entity profile 122 for use in controlling access to the interactive computing environment 107. The risk assessment server 118 can then perform risk assessment validation operations or access control operations for validating or otherwise authenticating (e.g., using other suitable modules, models, components, etc. of the risk assessment server 118) received data such as authentication data received from the user computing systems 106. In some aspects, the risk assessment application 114 can authenticate the request by utilizing the entity profile 122, or any score determined therefrom. The entity profile 122 can be determined based on one or more signals determined using received entity data that can include real-time streamed data about the target entity, real-time produced data about the target entity, historical data associated with the target entity, etc. The signals can be determined and stored in one or more network-attached storage units on which various repositories, databases, or other structures are stored. Examples of these data structures can include the risk data repository 123. Additionally or alternatively, a training dataset 126 can be stored in the risk data repository 123. In some examples, the training dataset 126 can be used to train one or more machine-learning models, which may include the risk assessment application 114, the entity profile model 112, and the like. The one or more machine-learning models can be trained to determine the entity profile 122, to determine scores about the target entity based on the entity profile 122, to control access to the interactive computing environment 107 using the entity profile 122 or scores determined therefrom, or otherwise provide digital enablement for the target entity.

Network-attached storage units may store a variety of different types of data organized in a variety of different ways and from a variety of different sources. For example, the network-attached storage unit may include storage other than primary storage located within the risk assessment server 118 that is directly accessible by processors located therein. In some aspects, the network-attached storage unit may include secondary, tertiary, or auxiliary storage, such as large hard drives, servers, and virtual memory, among other types of suitable storage. Storage devices may include portable or non-portable storage devices, optical storage devices, and various other mediums capable of storing and containing data. A machine-readable storage medium or computer-readable storage medium may include a non-transitory medium in which data can be stored and that does not include carrier waves or transitory electronic signals. Examples of a non-transitory medium may include, for example, a magnetic disk or tape, optical storage media such as a compact disk or digital versatile disk, flash memory, memory devices, or other suitable media.

Furthermore, the risk assessment computing system 130 can communicate with various other computing systems. The other computing systems can include user computing systems 106 (e.g., smartphones, personal computers, etc.), client computing systems 104, and other suitable computing systems. For example, user computing systems 106 may send (e.g., in response to receiving input from the target entity) requests for accessing the interactive computing environment 107 to the client computing systems 104. In response, the client computing systems 104 can send the authentication queries to the risk assessment server 118, and the risk assessment server 118 can receive entity data about the target entity for generating and using the entity profile 122. While FIG. 1 shows that the risk assessment computing system 130 and the client computing systems 104 are separate systems, they can be one system. For example, the risk assessment computing system 130 can be a part of the client computing systems 104.

As illustrated in FIG. 1, the risk assessment computing system 130 may interact with the client computing systems 104, the user computing systems 106, or a combination thereof via one or more public data networks 108 to facilitate interactions between users of the user computing systems 106 and the interactive computing environment 107. For example, the risk assessment computing system 130 can facilitate the client computing systems 104 providing a user interface to the user computing system 106 for receiving various data from the user. The risk assessment computing system 130 can transmit validated risk assessment data, for example the entity profile 122, scores determined therefrom, etc., to the client computing systems 104 for providing (or challenging, rejecting, etc.) access of the target entity to the interactive computing environment 107. In some examples, the risk assessment computing system 130 can additionally communicate with third-party systems (e.g., to receive additional risk assessment or entity data, etc.) through the public data network 108. For example, the third-party systems can provide real-time (e.g., streamed) data about the target entity, historical data about the target entity, etc. to the risk assessment computing system 130.

Each client computing system 104 may include one or more devices such as individual servers or groups of servers operating in a distributed manner. A client computing system 104 can include any computing device or group of computing devices operated by a seller, lender, or other suitable entity that can provide products or services. The client computing system 104 can include one or more server devices. The one or more server devices can include or can otherwise access one or more non-transitory computer-readable media.

The client computing system 104 can further include one or more processing devices that can be capable of providing an interactive computing environment 107 (e.g., a user interface, etc.) that can perform various operations. The interactive computing environment 107 can include executable instructions stored in one or more non-transitory computer-readable media. The instructions providing the interactive computing environment can configure one or more processing devices to perform the various operations. In some aspects, the executable instructions for the interactive computing environment can include instructions that provide one or more graphical interfaces. The graphical interfaces can be used by a user computing system 106 to access various functions of the interactive computing environment 107. For instance, the interactive computing environment 107 may transmit data to and receive data (e.g., via the graphical interface) from a user computing system 106 to shift between different states of the interactive computing environment 107, where the different states allow one or more electronics interactions between the user computing system 106 and the client computing system 104 to be performed.

In some examples, the client computing system 104 may include other computing resources associated therewith (e.g., not shown in FIG. 1), such as server computers hosting and managing virtual machine instances for providing cloud computing services, server computers hosting and managing online storage resources for users, server computers for providing database services, and others. The interaction between the user computing system 106, the client computing system 104, and the risk assessment computing system 130, or any suitable sub-combination thereof may be performed through graphical user interfaces (e.g., the user interface) presented by the risk assessment computing system 130, the client computing system 104, other suitable computing systems of the computing environment 100, or any suitable combination thereof. The graphical user interfaces can be presented to the user computing system 106. Application programming interface (API) calls, web service calls, or other suitable techniques can be used to facilitate interaction between any suitable combination or sub-combination of the client computing system 104, the user computing system 106, and the risk assessment computing system 130.

A user computing system 106 can include any computing device or other communication device operated by a user or entity (e.g., the target entity), such as a consumer or a customer. The user computing system 106 can include one or more computing devices such as laptops, smartphones, and other personal computing devices. A user computing system 106 can include executable instructions stored in one or more non-transitory computer-readable media. The user computing system 106 can additionally include one or more processing devices configured to execute program code to perform various operations. In various examples, the user computing system 106 can allow a user to access certain online services or other suitable products, services, or computing resources from a client computing system 104, to engage in mobile commerce with the client computing system 104, to obtain controlled access to electronic content (e.g., the interactive computing environment 107) hosted by the client computing system 104, etc.

For instance, the target entity can use the user computing system 106 to engage in an electronic interaction with the client computing system 104 via the interactive computing environment 107. The risk assessment computing system 130 can receive a request, for example from the user computing system 106, to access the interactive computing environment 107 and can use data (e.g., the entity profile 122 or any suitable scores determined therefrom) to determine whether to provide access, to challenge the request, to deny the request, etc. An electronic interaction between the user computing system 106 and the client computing system 104 can include, for example, the user computing system 106 being used to request a financial loan or other suitable services or products from the client computing system 104, and so on. An electronic interaction between the user computing system 106 and the client computing system 104 can also include, for example, one or more queries for a set of sensitive or otherwise controlled data, accessing online financial services provided via the interactive computing environment 107, submitting an online credit card application or other digital application to the client computing system 104 via the interactive computing environment 107, operating an electronic tool within the interactive computing environment 107 (e.g., a content-modification feature, an application-processing feature, etc.), etc.

In some aspects, an interactive computing environment 107 implemented through the client computing system 104 can be used to provide access to various online functions. As a simplified example, a user interface or other interactive computing environment 107 provided by the client computing system 104 can include electronic functions for requesting computing resources, online storage resources, network resources, database resources, or other types of resources. In another example, a website or other interactive computing environment 107 provided by the client computing system 104 can include electronic functions for obtaining one or more financial services, such as an asset report, management tools, credit card application and transaction management workflows, electronic fund transfers, etc.

A user computing system 106 can be used to request access to the interactive computing environment 107 provided by the client computing system 104. The client computing system 104 can submit a request (e.g., in response to a request made by the user computing system 106 to access the interactive computing environment 107) for risk assessment to the risk assessment computing system 130 and can selectively grant or deny access to various electronic functions based on risk assessment performed by the risk assessment computing system 130. Based on the request, the risk assessment computing system 130 can determine the entity profile 122 for a target entity that submitted the request via the user computing system 106. Based on the entity profile 122, or any suitable score determined therefrom, generated by the risk assessment server 118, the risk assessment computing system 130, the client computing system 104, or a combination thereof can determine whether to grant the access request of the user computing system 106 to certain features of the interactive computing environment 107.

In a simplified example, the system depicted in FIG. 1 can configure the risk assessment server 118 to be used for controlling access to the interactive computing environment 107. The risk assessment server 118 can receive data about a target entity that submitted a request to access the interactive computing environment 107, for example, based on the information provided by the client computing system 104 (e.g., information collected by the client computing system 104 via a user interface provided to the user computing system 106) or received via other suitable computing systems. The risk assessment server 118 can receive, for example from the entity profile server 110, the entity profile 122 for the target entity such that the entity profile 122 is based on the received data about the target entity. The risk assessment server 118 can determine one or more scores for the target entity based on the entity profile 122. The risk assessment server 118 can transmit the one or more scores, or the entity profile 122 itself, to the client computing system 104 for use in controlling access to the interactive computing environment 107.

In some examples, the entity profile 122 or any suitable score determined therefrom can be utilized (e.g., by the risk assessment computing system 130, the client computing system 104, etc.) to determine whether the risk associated with the target entity accessing a service provided by the client computing system 104 exceeds a threshold, thereby granting, challenging, or denying access by the target entity to the interactive computing environment 107. For example, if the risk assessment computing system 130 determines that the entity profile 122 or associated scores indicate that risk of the target entity is lower than a threshold value, then the client computing system 104 associated with the service provider can generate or otherwise provide access permission to the user computing system 106 that requested the access. The access permission can include, for example, cryptographic keys used to generate valid access credentials or decryption keys used to decrypt access credentials. The client computing system 104 can also allocate resources to the target entity and provide a dedicated web address for the allocated resources to the user computing system 106, for example, by adding the user computing system 106 in the access permission. With the obtained access credentials or the dedicated web address, the user computing system 106 can establish a secure network connection to the interactive computing environment 107 hosted by the client computing system 104 and access the resources via invoking API calls, web service calls, HTTP requests, other suitable mechanisms or techniques, etc.

In some examples, the risk assessment computing system 130 may determine whether to grant, challenge, or deny the access request made by the user computing system 106 for accessing the interactive computing environment 107. For example, based on the entity profile 122 or associated scores, the risk assessment computing system 130 can determine that the target entity is a legitimate entity that made the access request and may authenticate the request. In other examples, the risk assessment computing system 130 can challenge or deny the access attempt if the risk assessment computing system 130 determines that the target entity may not be a legitimate entity.

Each communication within the computing environment 100 may occur over one or more data networks, such as a public data network 108, a network 116 such as a private data network, or some combination thereof. A data network may include one or more of a variety of different types of networks, including a wireless network, a wired network, or a combination of a wired and wireless network. Examples of suitable networks include the Internet, a personal area network, a local area network (“LAN”), a wide area network (“WAN”), or a wireless local area network (“WLAN”). A wireless network may include a wireless interface or a combination of wireless interfaces. A wired network may include a wired interface. The wired or wireless networks may be implemented using routers, access points, bridges, gateways, or the like, to connect devices in the data network.

The number of devices depicted in FIG. 1 is provided for illustrative purposes. Different numbers of devices may be used. For example, while certain devices or systems are shown as single devices in FIG. 1, multiple devices may instead be used to implement these devices or systems. Similarly, devices or systems that are shown as separate, such as the risk assessment server 118 and the risk data repository 123, may be instead implemented in a single device or system. Similarly and as discussed above, the risk assessment computing system 130 may be a part of the client computing system 104.

### Techniques for Generating an Entity Profile for a Target Entity

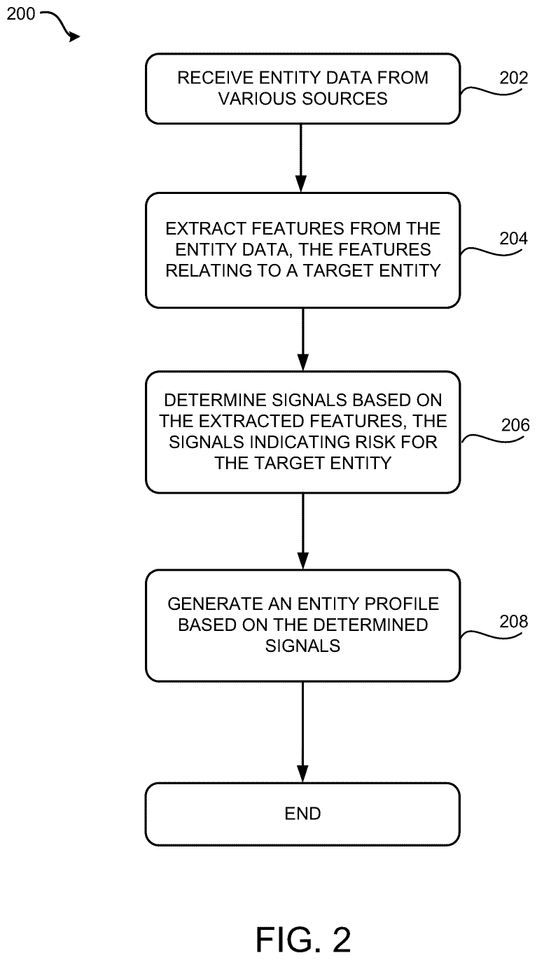

FIG. 2 is a flow chart depicting an example of a process 200 for generating an entity profile 122 according to certain aspects of the present disclosure. One or more computing devices (e.g., the risk assessment computing system 130) implement operations depicted in FIG. 2 by executing suitable program code (e.g., the entity profile model 112). For illustrative purposes, the process 200 is described with reference to certain examples depicted in the figures. Other implementations, however, are possible.

At block 202, the process 200 involves receiving entity data, about a target entity, from various sources. The target entity can include a user or other suitable entity that can submit a request via a user computing system 106 to access an interactive computing environment 107 or request other suitable resources. In some examples, the entity data includes real-time data about the target entity streamed from external data sources, real-time data about the target entity produced from internal data sources, historical interaction data about the target entity, other suitable entity data, or any suitable combination thereof. The real-time data about the target entity can be streamed data received from an external data source, such as a third-party data provider, a provider of products or services, or other suitable external sources of data. Additionally or alternatively, the risk assessment computing system 130 can produce, in real-time, data about the target entity. The produced data can include real-time interaction data about the target entity stored by the risk assessment computing system 130, for example in the risk data repository 123. The historical data about the target entity can be received from an external source, can be accessed by the risk assessment computing system 130, or can otherwise be received by the risk assessment computing system 130.

At block 204, the process 200 involves extracting features from the entity data. In some examples, the features can relate to the target entity. The features can include indications of behavior of the target entity. For example, the features can include instances of interactions in which the target entity is involved. In some examples, the features are individual, measurable properties or characteristics of information represented by the entity data. In one such example, the features can include metadata about one or more particular interactions in which the target entity is involved. The target entity can engage in an online interaction, and features, such as a time of the online interaction, a geographic location from which the online interaction originated, an amount of resources requested or exchanged with respect to the online interaction, personally identifiable information provided by the target entity with respect to the online interaction, and other suitable features relating to the online interaction. In some examples, the features can be extracted from real-world interactions included in the entity data. For example, features relating to a real-world interaction, for example requesting resources at a financial institution, can include an amount of the requested resources, a reason for requesting the resources, information provided by the target entity for requesting the resources, and other suitable features of the real-world interaction. Other suitable features can be extracted by the risk assessment computing system 130 using the entity data.

At block 206, the process 200 involves determining signals based on the extracted features associated with the entity data. In some examples, the signals indicate various types of risk associated with the target entity. The signals can be generated using the extracted features. For example, each signal determined by the risk assessment computing system 130 can include a set of the extracted features. In one such example, a signal relating to an amount of interactions initiated by the target entity within a predetermined time period can be generated by combining features extracted by the risk assessment computing system within the predetermined time period. In another example, a signal relating to an amount of resources requested can be generated by combining extracted features relating to amounts of resources requested by the target entity for various interactions. In yet another example, a signal relating to an identity of the target entity can be generated by combining features relating to personally identifiable information provided by the target entity with respect to various interactions included in the entity data.

In some examples, each signal can include an indication of risk associated with the target entity. For example, a signal relating to the identity of the target entity can indicate whether the identity provided by the target entity is legitimate. In another example, a signal relating to the amount of resources requested by the target entity can indicate whether the request for resources by target entity is legitimate, whether the target entity can satisfy conditions (e.g., repayment, etc.) associated with the request for resources, etc. Each of the signals can indicate a positive risk, a negative risk, or a neutral risk. For example, a first signal can indicate a positive risk such that providing access to the interactive computing environment 107 or providing resources to the target entity is not risky based on the first signal. In another example, a second signal can indicate a negative risk such that providing access to the interactive computing environment 107 or providing resources to the target entity is risky (e.g., fraud or other malicious activity may occur) based on the second signal. In yet another example, a third signal can indicate a neutral risk such that providing access to the interactive computing environment 107 or providing resources to the target entity is neither risky nor not risky based on the third signal.

At block 208, the process 200 involves generating an entity profile 122 for the target entity based on the signals. The risk assessment computing system 130 can generate the entity profile 122 by combining the signals. In some examples, the risk assessment computing system 130 can aggregate or concatenate the signals into the entity profile 122 such that the entity profile 122 is a collection of the signals. In other examples, the risk assessment computing system 130 can use the signals to generate one or more risk scores that can be aggregated or otherwise combined to generate the entity profile 122. The signals (e.g., risk signals) can be combined via proprietary machine-learning models, heuristics-based decision models, pattern-based simulations and/or behavior-based simulations, or the like. Various entity-specific or identity-specific scores, flags, weights, and indicators can be combined to provide risk assessments and/or risk scores. The risk scores can include a credit score, a fraud score, or any other suitable score that indicates an amount of risk associated with the target entity. Other suitable techniques can be used to generate the entity profile 122 based on the signals.

The entity profile 122 can continuously be updated. For example, periodically (e.g., every few seconds, few minutes, few hours, etc.) or in response to receiving input, the risk assessment computing system 130 can receive or produce updated entity data, can extract updated or new features, and can generate updated or new signals. The risk assessment computing system 130 can use the updated or new signals to generate an updated entity profile after each period of time or in response to receiving input.

In some examples, the risk assessment computing system 130 can tag (e.g., by applying crumbs or other indicators) one or more of the generated signals. For example, a signal can be passive or active. A passive signal may not contribute much, if any, indication whether the passive signal, or any features thereof, contributes to risk. Accordingly, the risk assessment computing system 130 can tag the passive signal as passive or any other suitable tag. An active signal may contribute a non-negligible amount of indication that the active signal, or any features thereof, contributes to risk. Accordingly, the risk assessment computing system 130 can tag the active signal as active or any other suitable tag. In response to tagging the signals, the risk assessment computing system 130 can selectively use the signals to generate the entity profile 122. For example, the risk assessment computing system 130 can use signals tagged as active, or any other suitable or similar tag, to generate the entity profile 122, for example by determining risk scores based on the active signals, while not using the signals tagged as passive or any other suitable or similar tag. Instead, the risk assessment computing system 130 can archive, delete, or otherwise remove the passive signals from consideration with respect to generating the entity profile 122.

### Techniques for Controlling Access to a Computing Environment Using an Entity Profile

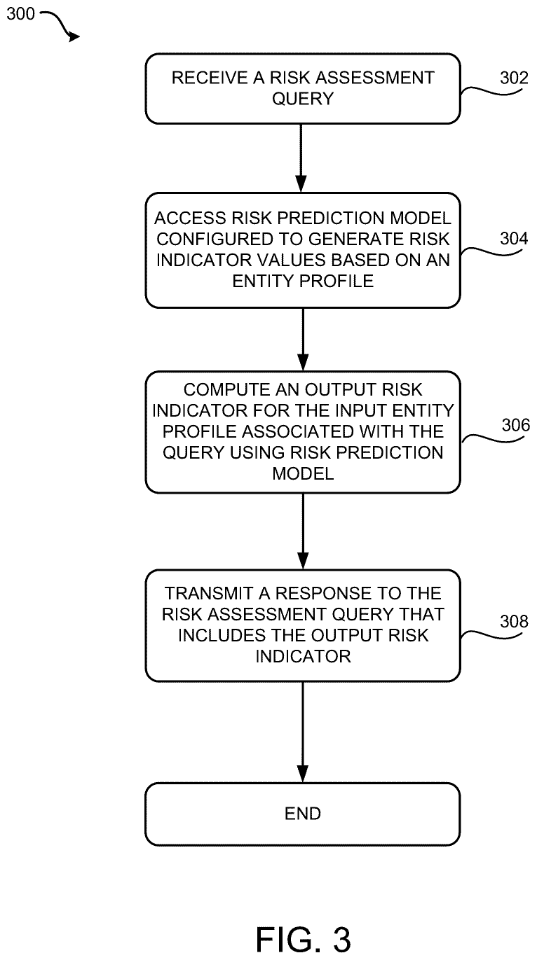

FIG. 3 is a flow chart depicting an example of a process 300 for controlling access to an interactive computing environment 107 using an entity profile 122 according to certain aspects of the present disclosure. One or more computing devices (e.g., the risk assessment computing system 130) implement operations depicted in FIG. 3 by executing suitable program code (e.g., the entity profile model 112). For illustrative purposes, the process 300 is described with reference to certain examples depicted in the figures. Other implementations, however, are possible.

At block 302, the process 300 involves receiving a risk assessment query for a target entity from a remote computing device, such as a computing device associated with the target entity requesting the risk assessment. The risk assessment query can also be received by the risk assessment server 118 from a remote computing device associated with an entity authorized to request risk assessment of the target entity.

At block 304, the process 300 involves accessing a risk prediction model 120 trained to generate risk indicator values based on an entity profile 122 associated with a target entity. In some examples, the risk prediction model 120 may additionally or alternatively be or include one or more proprietary models (e.g., machine-learning models, etc.), one or more heuristics models, and/or one or more simulation models. The entity profile 122 can be generated based on signals determined from a set of features extracted from entity data received by the risk assessment computing system 130. As described in more detail with respect to FIG. 1 above, examples of entity data can include real-time data and historical data associated with the target entity that describes prior actions or interactions involving the target entity (e.g., information that can be obtained from credit files or records, financial records, consumer records, online interactions, or other data about the activities or characteristics of the entity), behavioral traits of the target entity, demographic traits of the target entity, or any other traits that may be used to predict risks associated with the target entity. In some aspects, the historical data about the target entity can be obtained from credit files, financial records, consumer records, etc.

The features extracted from the entity data can include values of the entity data of a predefined period of time. For example, the features can include financial records over a twelve-month period, behavioral traits over a twelve-month period, etc. The risk indicator can indicate a level of risk associated with the entity, such as a credit score or fraud score of the entity. In some examples, the entity profile 122 can be used to determine the risk indicator. For example, the risk prediction model 120 can use signals included in the entity profile 122 to determine the risk indicator. In other examples, the risk assessment computing system 130 can determine one or more risk indicators and generate the entity profile 122 using the risk indicators. Accordingly, the risk prediction model 120 can query the entity profile 122 to determine a desired risk indicator, the risk prediction model 120 can combine the one or more risk indicators included in the entity profile 122 to generate an aggregate risk indicator, etc. Additionally, the risk prediction model 120 can be constructed and trained based on training samples including training entity profiles, signals, and features and training risk indicator outputs (also referred to as “risk indicator labels”).

At block 306, the process 300 involves computing a risk indicator for the target entity based on the entity profile 122 using the risk prediction model 120. The entity profile 122, or any suitable risk score determined or received therefrom, can be used as input to the risk prediction model 120. The entity profile 122 associated with the target entity can be generated by extracting features from received or produced entity data and by determining signals based on the extracted features. The output of the risk prediction model 120 can include the risk indicator for the target entity.

At block 308, the process 300 involves transmitting a responsive message based on the risk indicator (e.g., determined at block 306). In some examples, the risk assessment server 118 (or any other suitable module, model, or computing device) can transmit the responsive message to a computing device (e.g., the client computing system 104) or any other suitable computing device that can control access to the interactive computing environment 107. The responsive message can vary based on the risk indicator. For example, the responsive message may indicate that the target entity submitting the access request is the legitimate entity and may recommend granting access to the interactive computing environment 107 based on the request. In other examples, the responsive message may indicate that the entity is unknown or otherwise not associated with legitimate activity and may recommend challenging or denying the request.

In some examples, the responsive message may be generated and transmitted based on the entity profile 122. For example, the risk prediction model 120 can generate one or more risk indicators for the target entity, and the risk assessment server 118 can generate the responsive message based on the one or more risk indicators. The one or more risk indicators can include a credit score, a fraud score, an identity score, other suitable scores indicating risk in one or more multiple dimensions associated with the target entity, or any suitable combination thereof. The risk prediction model 120 can generate the risk indicator based on signals included in the entity profile 122, can generate the risk indicator by querying the entity profile 122 for a particular risk score included in the entity profile 122, and the like. The risk assessment server 118 can determine, based on the one or more risk indicators generated by the risk prediction model 120, whether to recommend granting, challenging, or denying the request submitted by the target entity. In some examples, the risk assessment computing system 130 can generate and transmit the responsive message to grant, challenge, or deny the request based on a recommendation provided by the risk prediction model 120.

### Architecture for Generating an Entity Profile

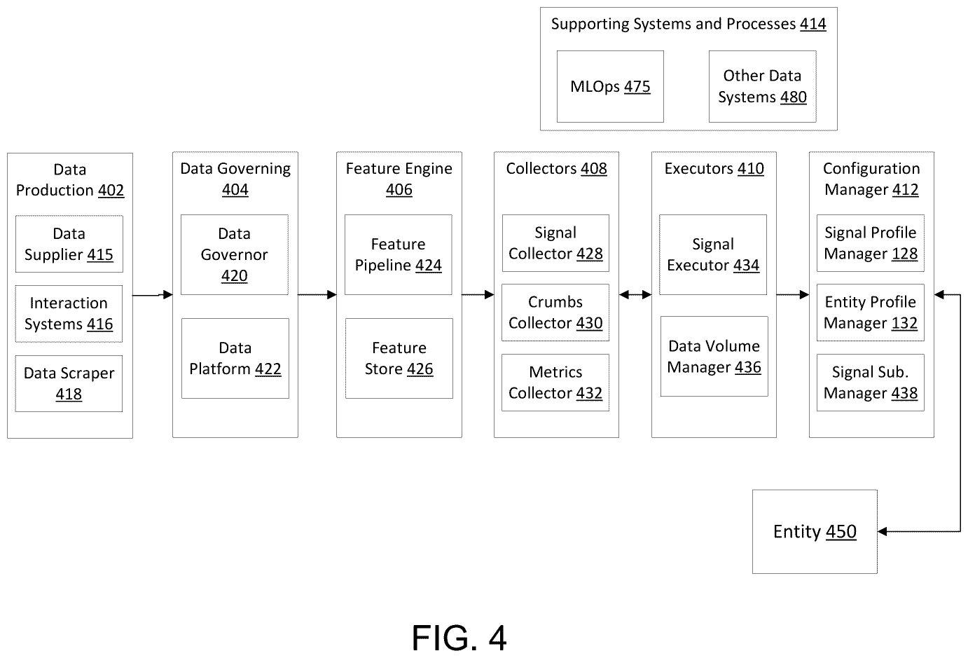

FIG. 4 is a schematic depicting an example of an architecture of an entity profile model 112 for generating an entity profile 122 according to certain aspects of the present disclosure. As illustrated, the entity profile model 112 includes a data production module 402, a data governing module 404, a feature engine 406, a collectors module 408, an executors module 410, a configuration manager 412, and supporting systems 414, which can include MLOps 475 and supporting systems 480. The entity profile model 112 can include any other suitable modules and the like for configuring the entity profile model 112 to generate the entity profile 122.

The data production module 402 can include a data supplier 415, interaction systems 416, a data scraper 418, and any other suitable components for producing, accessing, or otherwise receiving entity data about a target entity. The data supplier 415 can provide data relating to the target entity. For example, the data supplier 415 can provide real-time data, accessible by the entity profile model 112, about the target entity. In some examples, the data supplier 415 may supply or otherwise produce real-time data from internal data sources with respect to the risk assessment computing system 130. The interaction systems 416 can include systems that can communicate with external sources of data. For example, the interaction systems 416 can communicate with one or more external computing devices that can provide real-time data about interactions that involve the target entity. In some examples, the interaction systems 416 can receive real-time data about the target entity from one or more external sources. The data scraper 418 can search or query an online environment (e.g., the Internet) to access additional information about the target entity. The additional information can include historical interaction data about previously executed or otherwise historical interactions that involved the target entity. The data production module 402 can execute each of the data supplier 415, the interaction systems 416, and the data scraper 418 for generating entity data for use in generating the entity profile 122.

The data governing module 404 can include a data governor 420, a data platform 422, and any other suitable components for governing data in the entity profile model 112. The data governor 420 can catalog the entity data, can tag the entity data, and can perform other suitable tasks with respect to managing the entity data. The data platform 422 can receive the entity data from the data production module 402 and can store the entity data for subsequent use. For example, the data platform 422 can receive the entity data and can convert the entity data to a format that can be used by other modules of the entity profile model 112.

The feature engine 406 can include a feature pipeline 424, a feature store 426, and any other suitable components for generating, extracting, or otherwise determining features from the entity data. The feature pipeline 424 can extract features or attributes from usable data. For example, the feature pipeline 424 can access the usable entity data stored by the data platform 422 and can extract features or attributes from the usable entity data. The extracted features can be used to determine signals for the entity profile 122. In one such example, the feature pipeline 424 can extract features including personally identifiable information, a time or location of the request, and the like from the entity data associated with the target entity. The feature pipeline 424 can transmit the extracted features to the feature store 426. The feature store 426 can store the extracted features for use in generating signals for the entity profile 122.

The collectors module 408 can include a signal collector 428, a crumbs collector 430, a metrics collector 432, and any other suitable collector that can be used to facilitate signal generation for the entity profile 122. The signal collector 428 can access the extracted features stored via the feature store 426 and can generate signals based on the extracted features. For example, the signal collector 428 can generate a signal by combining a set of related features about the target entity such that the signal can indicate whether the set of related features increases or decreases a risk in multiple dimensions associated with the target entity. Accordingly, each signal generated by the signal collector 428 can include, or can be based on, one or more features extracted by the feature pipeline 424. The crumbs collector 430 can tag each signal, or any subset thereof, generated by the signal collector 428. For example, the crumbs collector 430 can tag a particular signal as a passive signal, an active signal, etc. In some examples, the crumbs collector 430 can tag each data point included in one or more signals as passive data, active data, etc. Active signals or active data may include signals or data that contribute non-negligibly to one or more risk indicators for the target entity, while passive signals or passive data may not contribute (or may not essentially contribute) to the one or more risk indicators. The crumbs collector 430 can otherwise suitably tag the signals, or the data thereof, for generating the entity profile 122. The metrics collector 432 can collect metrics relating to the entity data included in the signals. For example, the metrics collector 432 can collect metrics relating to an interaction type, metadata about interactions, and the like relating to the entity data of the signals.

The executors module 410 can include a signal executor 434 and a data volume manager 436. The signal executor 434 can generate the entity profile 122 based on the signals generated via the collectors module 408. In some examples, the signal executor 434 can update an existing entity profile 122 based on updated signals generated by the collectors module 408. For example, the signal executor 434 can use the generated signals to determine one or more risk scores about the target entity and update one or more risk profiles, included in the entity profile 122, of the target entity based on the one or more risk scores. In another example, the signal executor 434 can determine an aggregate risk score based on the generated signals and can update the entity profile 122 based on the aggregate risk score. The data volume manager 436 can identify tags applied to the signals, or the data thereof, and can manage an amount of data used to generate the new entity profile 122 or to update the existing entity profile 122. For example, the data volume manager 436 can search the signals and the data included therein to identify each instance of a passive tag. Additionally, for each instance of a passive tag, the data volume manager 436 can delete, archive, remove, or otherwise prevent the associated signals or data from being executed by the signal executor 434. Accordingly, the signal executor 434 can generate or update the entity profile 122 using a subset of the received entity data. And the entity profile model 112 can more quickly, efficiently, and using fewer computational resources (e.g., computer memory, processing power, etc.), generate or update the entity profile 122.

The configuration manager 412 can include a signal profile manager 128, an entity profile manager 132, a signal subscription manager 438, and any other suitable managing components for the configuration manager 412. The signal profile manager 128 can receive input from one or more machine-learning models, entities (e.g., users of the client computing systems 104, etc.), and the like for maintaining signal profiles for a particular entity such as the target entity, the user of the client computing system 104, etc. In some examples, the signal profile can be used to determine whether a particular signal is a positive signal, a negative signal, or neither. For example, the signal executor 434 can access the signal profile manager 128 to determine whether the signals generated by the signal collector 428 positively affect, negatively affect, or do not affect one or more risk indicators associated with the target entity. Based on indications provided by the signal profile manager 128, the signal executor 434 can generate or update the entity profile 122.

The entity profile manager 132 can manage the newly generated entity profile, an existing entity profile, or suitable combinations thereof. For example, in response to the signal executor 434 generating a new entity profile 122 for the target entity, the entity profile manager 132 can store and manage the new entity profile 122. Additionally, the entity profile manager 132 can store or otherwise manage an existing entity profile 122, and the entity profile manager 132 can facilitate updates to the entity profile 122 performed by the signal executor 434. In some examples, the entity profile manager 132 can provide one or more entity profiles 122 about the target entity to an entity 450. For example, the entity 450 can be or otherwise include a provider or products or services from which the target entity has requested resources. The entity 450 can communicate, for example at least indirectly through the risk assessment computing system 130, with the configuration manager 412 and can request the entity profile 122 from the entity profile manager 132. In some examples, the entity profile manager 132 can provide the entity profile 122 in response to the request. In other examples, the entity profile manager 132 can facilitate the risk assessment computing system 130 providing the entity 450 with one or more risk indicators based on the relevant entity profile.

The signal subscription manager 438 can allow entities (e.g., the entity 450) to subscribe to one or more particular signals. For example, the entity 450 can subscribe to the entity profile model 112 to receive notifications relating to a signal and, in some instances, with respect to the target entity. Upon the entity profile model 112 generating or detecting a change to the signal, the entity profile model 112 can transmit a notification to the entity 450 that indicates a change to the signal.

The supporting systems 414 can include the MLOps 475 and the supporting systems 480. The MLOps 475 and/or the supporting systems 480 can be used to generate, maintain, tune, or otherwise control the entity profile model 112. For example, the MLOps 475 and/or the supporting system 480 can determine an effectiveness of the entity profile model 112, can determine how often to maintain or update the entity profile model 112, and can provide other suitable support services for the entity profile model 112.

### Exemplary Diagram of an Entity Profile

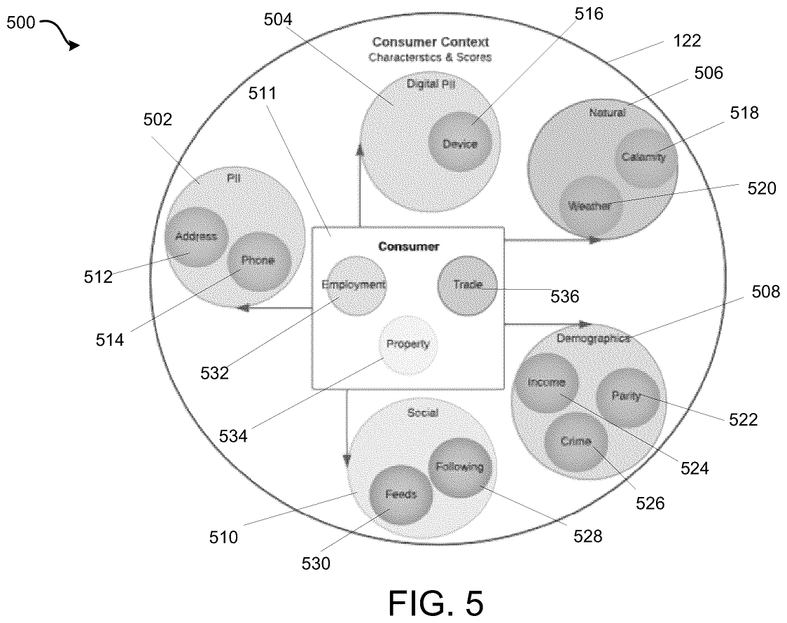

FIG. 5 is a diagram depicting a visualization 500 of an entity profile 122 according to certain aspects of the present disclosure. In some examples, the entity profile 122 can include characteristics, scores, signals, and other suitable information about the target entity. As illustrated, the entity profile 122 includes signals including personally identifiable information 502, digital personally identifiable information 504, natural data 506, demographic data 508, social data 510, and consumer data 511. The entity profile 122 can include any other suitable information relating to behavior, identity, and the like about the target entity.

The personally identifiable information 502 can include an address 512 of the target entity, a phone number 514 of the target entity, and other personally identifiable information 502 associated with the target entity. The digital personally identifiable information 504 can include a device 516 used by the target entity and any other suitable digital personally identifiable information (e.g., IP address, etc.) about the target entity. The natural data 506 can include calamity 518 and weather 520. Calamity 518 can include any suitable adverse events (e.g., civil war, rioting, crime, natural disaster, artificial disaster, etc.) occurring at or near a location of the target entity, and weather 520 can include reported or predicted weather occurring at or near the location of the target entity. The demographic data 508 can include parity 522, income 524, and crime 526 associated with the target entity. The parity 522 can be an actual or perceived level of fairness associated with the target entity with respect to entities similar to the target entity. The income 524 can include an indication of wealth owned or controlled by the target entity, and the crime 526 can include an indication of whether or what crimes the target entity has been suspected of, convicted of, or the like. The social data 510 can include follows 528 and feeds 530. In some examples, the social data 510 may relate to, or otherwise be determined from, social media history or activity of the target entity. For example, the follows 528 may indicate or otherwise represent entities or individuals that the target entity follows with respect to one or more social media outlets. Additionally, the feeds 530 may indicate or otherwise represent content created or disseminated by the target entity online. The consumer data 511 can include an employment 532 (e.g., employment history, type of employment, etc.) of the target entity, property 534 associated with the target entity, trade 536 (e.g., investment accounts, etc.) associated with the target entity, and any other suitable consumer data about the target entity.

The entity profile 122 can be used to facilitate decisions with respect to the target entity. For example, the risk assessment computing system 130 can generate one or more risk indicators based on the entity profile 122. The risk indicators can be determined using signals included in the entity profile 122, risk scores included in the entity profile 122, or any other data included in the entity profile 122. The entity profile 122 can be used to transmit messages. For example, the risk assessment computing system 130 can use the entity profile 122 to transmit a responsive message for controlling access of the target entity to the interactive computing environment 107. Additionally or alternatively, the risk assessment computing system 130 can use the entity profile 122 to transmit a responsive message for controlling one or more real-world interactions (e.g., resource loans, etc.). Generally, the entity profile 122 can be used for digital enablement of interactions involving the target entity. In particular, the risk assessment computing system 130 can use the signals included in the entity profile 122 to generate one or more risk indicators. For example, the risk assessment computing system 130 can use the personally identifiable information 502 and the digital personally identifiable information 504 signals to generate an identity risk score that indicates a likelihood that the target entity is genuinely being identified in a particular interaction. Other techniques for controlling interactions using the entity profile 122 are possible.

### Example of Computing System

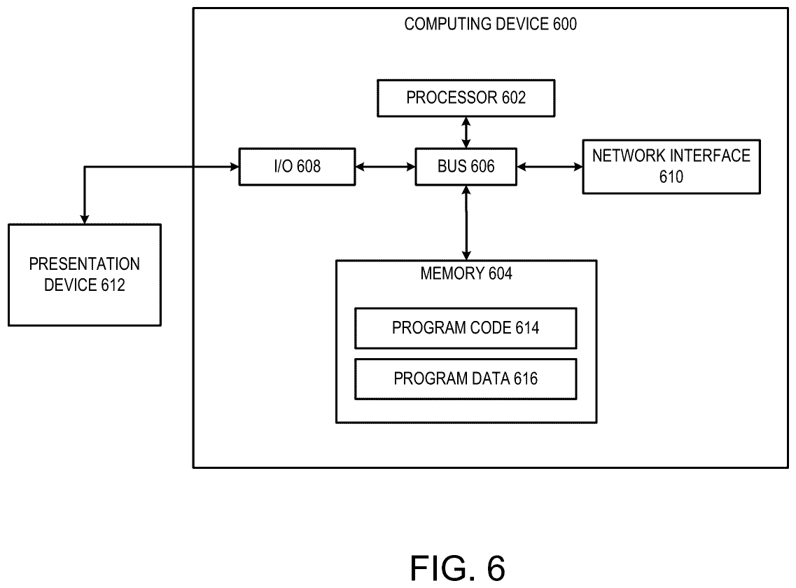

Any suitable computing system or group of computing systems can be used to perform the operations for the machine-learning operations described herein. For example, FIG. 6 is a block diagram depicting an example of a computing device 600, which can be used to implement the risk assessment server 118 or other suitable components of the computing environment 100. The computing device 600 can include various devices for communicating with other devices in the computing environment 100, as described with respect to FIG. 1. The computing device 600 can include various devices for performing one or more data consolidation or validation (or other suitable) operations described above with respect to FIGS. 1-4.

The computing device 600 can include a processor 602 that is communicatively coupled to a memory 604. The processor 602 can execute computer-executable program code stored in the memory 604, can access information stored in the memory 604, or both. Program code may include machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing or receiving information, data, arguments, parameters, or memory contents. Information, arguments, parameters, data, etc., may be passed, forwarded, or transmitted via any suitable means including memory sharing, message passing, token passing, network transmission, among others.

Examples of a processor 602 can include a microprocessor, an application-specific integrated circuit (ASIC), a field-programmable gate array (FPGA), or any other suitable processing device. The processor 602 can include any suitable number of processing devices, including one. The processor 602 can include or communicate with a memory 604. The memory 604 can store program code that, when executed by the processor 602, causes the processor 602 to perform the operations described herein.

The memory 604 can include any suitable non-transitory computer-readable medium. The computer-readable medium can include any electronic, optical, magnetic, or other storage device capable of providing a processor with computer-readable program code or other program code. Non-limiting examples of a computer-readable medium can include a magnetic disk, memory chip, optical storage, flash memory, storage class memory, ROM, RAM, an ASIC, magnetic storage, or any other medium from which a computer processor can read and execute program code. The program code may include processor-specific program code generated by a compiler or an interpreter from code written in any suitable computer-programming language. Examples of suitable programming language can include Hadoop, C, C++, C #, Visual Basic, Java, Python, Perl, JavaScript, ActionScript, etc.

The computing device 600 may also include a number of external or internal devices such as input or output devices. For example, the computing device 600 is illustrated with an input/output interface 608 that can receive input from input devices or provide output to output devices. A bus 606 can also be included in the computing device 600. The bus 606 can communicatively couple one or more components of the computing device 600.

The computing device 600 can execute program code 614 that can include the entity profile model 112. The program code 614 for the entity profile model 112 may be resident in any suitable computer-readable medium and may be executed on any suitable processing device. For example, as depicted in FIG. 6, the program code 614 for the entity profile model 112 can reside in the memory 604 at the computing device 600 along with the program data 616 associated with the program code 614, such as the signal data 124. Executing the entity profile model 112 can configure the processor 602 to perform the operations described herein.

In some aspects, the computing device 600 can include one or more output devices. One example of an output device can be the network interface device 610 depicted in FIG. 6. A network interface device 610 can include any device or group of devices suitable for establishing a wired or wireless data connection to one or more data networks described herein. Non-limiting examples of the network interface device 610 can include an Ethernet network adapter, a modem, etc.

Another example of an output device can include the presentation device 612 depicted in FIG. 6. A presentation device 612 can include any device or group of devices suitable for providing visual, auditory, or other suitable sensory output. Non-limiting examples of the presentation device 612 can include a touchscreen, a monitor, a speaker, a separate mobile computing device, etc. In some aspects, the presentation device 612 can include a remote client-computing device that communicates with the computing device 600 using one or more data networks described herein. In other aspects, the presentation device 612 can be omitted.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

What is claimed is:

1. A system comprising:
a processor; and
a non-transitory computer-readable medium comprising instructions that are executable by the processor to cause the processor to perform operations comprising:
receiving entity data relating to a target entity, the entity data comprising real-time data and external data;
extracting a plurality of features from the entity data;
generating one or more signals based on the plurality of features, each signal of the one or more signals comprising a subset of the plurality of features, and each signal of the one or more signals corresponding to an amount of risk associated with the target entity;
generating, based on the one or more signals, an entity profile; and
providing a responsive message based on the entity profile usable to control access to an interactive computing environment.

2. The system of claim 1, wherein the operations further comprise:
receiving a query for determining an entity risk for the target entity;
determining, using the entity profile, the entity risk for the target entity; and
providing a particular responsive message based on the query and the determined entity risk for use in a decisioning process relating to the target entity.

3. The system of claim 1, wherein the entity data comprises (i) real-time data about the target entity streamed from external data sources, (ii) real-time data about the target entity produced from internal data sources, (iii) historical interaction data about the target entity, or a combination thereof, and wherein extracting the plurality of features includes extracting each feature of the plurality of features based on (i) the real-time data about the target entity streamed from external data sources, (ii) the real-time data about the target entity produced from internal data sources, (iii) the historical interaction data about the target entity, or a combination thereof.

4. The system of claim 1, wherein the operation of generating the one or more signals includes determining, for each signal of the one or more signals, (i) that the signal is a positive signal, (ii) that the signal is a negative signal, or (iii) that the signal is a neutral signal, and wherein:
determining that the signal is the positive signal includes determining that the signal reduces a likelihood that the target entity is associated with fraud;
determining that the signal is the negative signal includes determining that the signal increases the likelihood that the target entity is associated with fraud; and
determining that the signal is the neutral signal includes determining that the signal does not affect the likelihood that the target entity is associated with fraud.

5. The system of claim 1, wherein the operations further comprise:
adjusting a particular signal of the one or more signals to generate a simulated signal;
determining whether the simulated signal (i) increases a likelihood that the target entity is associated with fraud, (ii) decreases the likelihood that the target entity is associated with fraud, or (iii) does not affect the likelihood that the target entity is associated with fraud; and
adjusting the entity profile based on the simulated signal.

6. The system of claim 1, wherein the operations further comprise:
determining, for each signal of the one or more signals, whether the signal represents active data included in the entity data or passive data included in the entity data;
tagging, in response to determining that a particular signal of the one or more signals represents the passive data, the particular signal of the one or more signals; and
pruning the one or more signals by removing the particular signal of the one or more signals.

7. The system of claim 1, wherein the entity profile associates a plurality of dimensions of the target entity with a plurality of different risk indicators, and wherein a subset of the plurality of different risk indicators is usable to determine an identity of the target entity with respect to an interaction in which the target entity is involved.

8. A method comprising:
receiving, by a processing device, entity data relating to a target entity, the entity data comprising real-time data and external data;
extracting, by the processing device, a plurality of features from the entity data;
generating, by the processing device, one or more signals based on the plurality of features, each signal of the one or more signals comprising a subset of the plurality of features, and each signal of the one or more signals corresponding to an amount of risk associated with the target entity;
generating, by the processing device and based on the one or more signals, an entity profile; and
providing, by the processing device, a responsive message based on the entity profile to control access to an interactive computing environment.

9. The method of claim 8, further comprising:
receiving, by the processing device, a query for determining an entity risk for the target entity;
determining, by the processing device and using the entity profile, the entity risk for the target entity; and
providing, by the processing device, a particular responsive message based on the query and the determined entity risk for use in a decisioning process relating to the target entity.

10. The method of claim 8, wherein the entity data comprises (i) real-time data about the target entity streamed from external data sources, (ii) real-time data about the target entity produced from internal data sources, (iii) historical interaction data about the target entity, or a combination thereof, and wherein extracting the plurality of features includes extracting, by the processing device, each feature of the plurality of features based on one or more of (i) the real-time data about the target entity streamed from external data sources, (ii) the real-time data about the target entity produced from internal data sources, or (iii) the historical interaction data about the target entity.

11. The method of claim 10, wherein generating the one or more signals includes determining, by the processing device and for each signal of the one or more signals, (i) that the signal is a positive signal, (ii) that the signal is a negative signal, or (iii) that the signal is a neutral signal, and wherein:
determining that the signal is the positive signal includes determining, by the processing device that the signal reduces a likelihood that the target entity is associated with fraud;
determining that the signal is the negative signal includes determining, by the processing device, that the signal increases the likelihood that the target entity is associated with fraud; and
determining that the signal is the neutral signal includes determining, by the processing device, that the signal does not affect the likelihood that the target entity is associated with fraud.

12. The method of claim 8, further comprising:
adjusting, by the processing device, a particular signal of the one or more signals to generate a simulated signal;
determining, by the processing device, whether the simulated signal (i) increases a likelihood that the target entity is associated with fraud, (ii) decreases the likelihood that the target entity is associated with fraud, or (iii) does not affect the likelihood that the target entity is associated with fraud; and
adjusting, by the processing device, the entity profile based on the simulated signal.

13. The method of claim 8, further comprising:
determining, by the processing device and for each signal of the one or more signals, whether the signal represents active data included in the entity data or passive data included in the entity data;
tagging, by the processing device and in response to determining that a particular signal of the one or more signals represents the passive data, the particular signal of the one or more signals; and
pruning, by the processing device, the one or more signals by removing the particular signal of the one or more signals.

14. The method of claim 8, wherein the entity profile associates a plurality of dimensions of the target entity with a plurality of different risk indicators, wherein the method further comprises determining, by the processing device and using at least a subset of the plurality of different risk indicators, an identity of the target entity with respect to an interaction in which the target entity is involved.

15. A non-transitory computer-readable medium comprising instructions that are executable by a processing device for causing the processing device to perform operations comprising:
receiving entity data relating to a target entity, the entity data comprising real-time data and external data;
extracting a plurality of features from the entity data;
generating one or more signals based on the plurality of features, each signal of the one or more signals comprising a subset of the plurality of features, and each signal of the one or more signals corresponding to an amount of risk associated with the target entity;
generating, based on the one or more signals, an entity profile; and
providing a responsive message based on the entity profile usable to control access to an interactive computing environment.

16. The non-transitory computer-readable medium of claim 15, wherein the operations further comprise:
receiving a query for determining an entity risk for the target entity;
determining, using the entity profile, the entity risk for the target entity; and
providing a particular responsive message based on the query and the determined entity risk for use in a decisioning process relating to the target entity.

17. The non-transitory computer-readable medium of claim 15, wherein the entity data comprises (i) real-time data about the target entity streamed from external data sources, (ii) real-time data about the target entity produced from internal data sources, (iii) historical interaction data about the target entity, or a combination thereof, and wherein the operation of extracting the plurality of features includes extracting each feature of the plurality of features based on one or more of (i) the real-time data about the target entity streamed from external data sources, (ii) the real-time data about the target entity produced from internal data sources, or (iii) the historical interaction data about the target entity.

18. The non-transitory computer-readable medium of claim 15, wherein the operation of generating the one or more signals includes determining, for each signal of the one or more signals, (i) that the signal is a positive signal, (ii) that the signal is a negative signal, or (iii) that the signal is a neutral signal, and wherein:
determining that the signal is the positive signal includes determining that the signal reduces a likelihood that the target entity is associated with fraud;
determining that the signal is the negative signal includes determining that the signal increases the likelihood that the target entity is associated with fraud; and
determining that the signal is the neutral signal includes determining that the signal does not affect the likelihood that the target entity is associated with fraud.

19. The non-transitory computer-readable medium of claim 15, wherein the operations further comprise:
adjusting a particular signal of the one or more signals to generate a simulated signal;
determining whether the simulated signal (i) increases a likelihood that the target entity is associated with fraud, (ii) decreases the likelihood that the target entity is associated with fraud, or (iii) does not affect the likelihood that the target entity is associated with fraud; and
adjusting the entity profile based on the simulated signal.

20. The non-transitory computer-readable medium of claim 15, wherein the operations further comprise:
determining, for each signal of the one or more signals, whether the signal represents active data included in the entity data or passive data included in the entity data;
tagging, in response to determining that a particular signal of the one or more signals represents the passive data, the particular signal of the one or more signals; and
pruning the one or more signals by removing the particular signal of the one or more signals.
